(19) United States
(12) Patent Application Publication
(10) Pub. No.: US 2023/0042985 A1
(43) Pub. Date: Feb. 9, 2023

(54) Laser Straightness Measuring Apparatus

(71) Applicant: Oren Aharon, Haifa (IL)

(72) Inventor: Oren Aharon, Haifa (IL)

(21) Appl. No.: 17/392,298

(22) Filed: Aug. 3, 2021

(51) Int. Cl. G01J 1/42; G01J 1/04

(52) U.S. Cl. CPC G01J 1/4257; G01J 1/0411; G01J 1/0414

(57) ABSTRACT

Apparatus for generating a laser line pattern for alignment, comprising of a collimated laser, a beam splitter, laser angular detection system, and a partially reflecting mirror equipped with a position detector on its back side. The laser beam is directed to the partially reflecting mirror, and the back reflection from said mirror is directed to an angular position aperture using a beam splitter. The angular position aperture will monitor the angle of reflection from said mirror as it moves along a path which its alignment accuracy is required. Moreover, said position detector mounted on partially reflecting mirror's back will monitor the position fluctuations in parallel to angular measurement performed by said angular measuring device. A method of generating a reference laser line is provided by a collimated laser, and deviations from laser beam path are recorded along a predeterminate section to yield position and angular behavior along the said predeterminate section.

### BACKGROUND OF THE INVENTION

### 1. Field of Invention

The present invention relates to industrial and optical alignment using a combination of projected laser entangled with an angular laser detector and lateral position detector as well. Industrial alignment is a need in many applications such as: The term ‘alignment’ may refer to measure position and angular deviation of an object relative to a given trajectory. In case of optical devices, accuracy measurements will relate to a pre-designed optical axis.

The innovation lies in implementing usage of an accurate laser, projecting a laser beam having a low divergence. Typical applications are: Shaft alignment, optical alignment, pully alignment, gantry straightness, laser alignment of machine tools, pipes alignment, spindle alignment, geometric alignment, parallelism of roll-to-roll alignment, energy turbines alignment and measurement, shaft alignment in ships and other large machines, silicon wafer alignment and many others.

### 2. Description of the Related Art

The innovation combines a highly accurate directed laser beam with an angular reading detection system.

There is a significant advantage in using a laser beam as a reference, since a laser beam has a perfect straight-line trajectory in space. By coupling that with capable measuring devices such as Anglemeter and lateral movement, an important solution is offered for many alignment applications. Misalignment of rotating machines or mechanical rails causes high damage and related costs to the industry. Straightness alignment as well as shaft alignment has been traditionally performed by using mechanical tools. However, since the laser projects a perfect reference straight line then it could be used for alignment. In this category alignment of optical system is usually performed by a digital autocollimator that uses an optical projected cross to check angular deviations as back reflected from a reference mirror. The concept of back reflection from a mirror is used on disclosed art by a projected laser beam that is not only back reflected but actually designates a point along the propagation axis from the laser that can be used for lateral displacement measurements in a surface which is perpendicular to the laser propagation axis.

### SUMMARY

The present invention is intended to offer a solution for accurate alignment measurements, and solve accuracy and measurement problems related to existing instrumentation. It is the object of present invention to provide an apparatus which offers an industrial solution to intricate alignment and Interalignment for all optics and mechanical setups. Additional objects of the present invention will be emphasized in the descriptions which follow and may be learned by practice of the invention. According to a first aspect of the present invention there is provided an apparatus for generating a laser beam coinciding with the center of a laser angular measuring device. To achieve the objectives in accordance with the present invention, the angular laser measuring device, is preferable based on position sensitive detector or CCD, and equipped with collimating lens disposed exactly one focal length from said sensitive detector. In front of the lens, another optical element is used, preferable a beam splitter, which splits a laser beam parallel to the lens surface into two directions—one of them coincides with the optics' line of sight. The laser beam irradiates along the center of the optical surface to create a perfect straight-line coinciding with the center of the optical system, this center point is traced by the laser beam along the propagation direction. A reflective surface disposed on the device to be measured will back-reflect the beam in a slightly different angle containing the angular information of the measured device. Said reflected beam will strike the lens aperture and focus on the position detector. The deviation of location on the position detector equipped with said lens will enable easy calculations of the incoming beam's angle.

The formula for angle calculation is given by θ=^{Δx}/_{F}% , wherein θ is the angular deviation of the incoming beam, x is the distance from the position sensitive detector's center to the focused laser beam on its surface. F is the focal length of the system. As the mirror is moved along the device to be aligned, its back reflection angle is recorded to generate angular deviations along the examined rail or device. Yet another application is feasible whenever the said reflective surface is partially reflective and has a position sensitive device on its back. By recording the laser position on its surface, lateral movements along the propagation line of the laser could be computed as well.

To summarize, an apparatus comprising a laser beam, a beam splitter in front of an optical laser angular sensitive device with an optical principal axis wherein the split laser propagation axis coincides with the optics' principal axis of said laser angular sensitive device, based on a focusing lens and a position sensitive detector which is placed in respect to the lens to generate the angular deviation of a reflected incoming beam. Said laser beam is split in two directions which are perpendicular to each other. Said beam spitter in front of the optical laser angular sensitive device splits the beam such that one of the splitted split beams coincides with said optical principal axis. Said optical laser angular sensitive device comprises of a lens and a sensitive detector which is placed in respective to the lens to generate an angular reading of a reflected incoming laser beam. A processor calculates the laser angular deviation and activates the laser emittance when necessary. Electronic information will further be processed by a processor or a computer. For alignment measurement, the projected beam generated by said laser straightness measuring device is back reflected by a mirror attached to the device to be measured. Entangled with this measurement device and embodiment wherein a partially-reflected mirror element back reflects a part of the laser beam and allows the other part to pass through to a position sensitive detector. Said laser beam could have a wavelength covering a wide spectral range. A method comprising: an optical element that includes a laser beam, a beam splitter in front of an optical laser angular sensitive device with an optical principal axis, wherein the split laser propagation axis coincides with the optics' principal axis of said laser angular sensitive device. Said laser beam is a reference for measurements of angular deviations from a reflective element which is attached to the device to be measured. The back reflected beam is monitored by an angle detection module which derives the angle by using said lens and the position sensitive device placed on its image plane.

### BRIEF DESCRIPTION OF THE DRAWINGS

For clarification, the various described embodiments are illustrated below. These figures are not drawn to scale and schematically describe the invention, but do not limit its applications.

FIG. 1 is a perspective view of the laser straightness measuring apparatus in accordance with some embodiments.

FIG. 2 is a cross-sectional view of the laser straightness measuring apparatus in accordance with some embodiments.

FIG. 3 is a schematic diagram illustrating the laser straightness measuring apparatus in conjunction with position sensitive device.

### DETAILED DESCRIPTION OF THE DRAWINGS

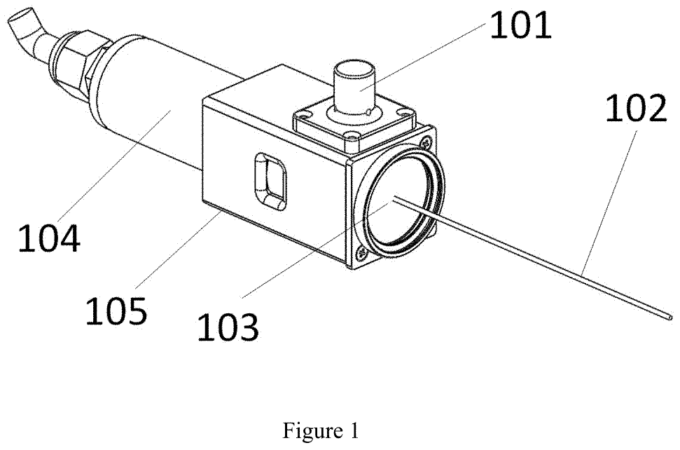

FIG. 1 illustrates a perspective view of laser straightness measuring apparatus, wherein the device is configured to project a laser beam 102, generated by a laser, preferable collimated diode laser, denoted as 101, using a beam splitter denoted as 103. Said beam 102 is projected to coincide with the mechanical center of the device denoted as 104. Moreover, yet another mechanical interface device at the bottom of the apparatus and denoted as 105 is used to further allow accurate mechanical attachments which are parallel to said laser beam.

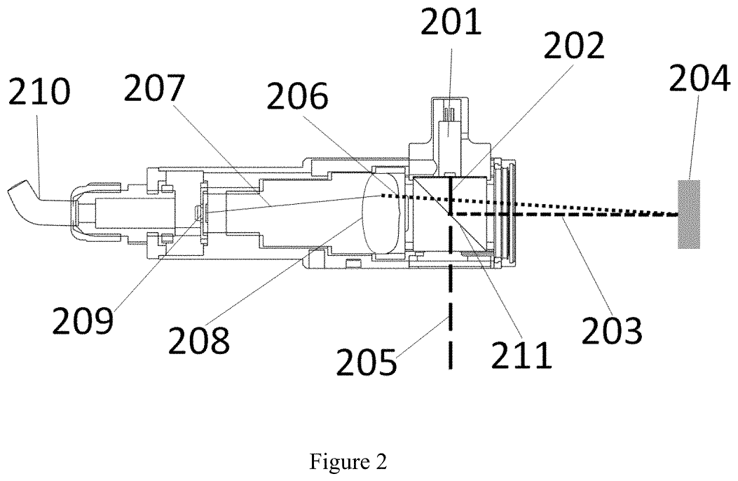

FIG. 2 is a cross-sectional view of the proposed art, showing the optical ray-trace of laser system and the back reflected beam detection system. A laser beam 202 generated by said collimated laser 201 is projected through a beam splitter 211, and is split into two perpendicular beams 203 and 205. A mirror denoted as 204 could be positioned on a member to be aligned and the reflected beam 206 will be focused by a focusing lens 208 and refracted at an angle. The refracted beam is denoted as 207. The beam strikes a position sensitive detector denoted as 209 and its location on said detector is translated into the angular deflection as represented by 206. This information is transmitted to a computer device via an electric cable 210.

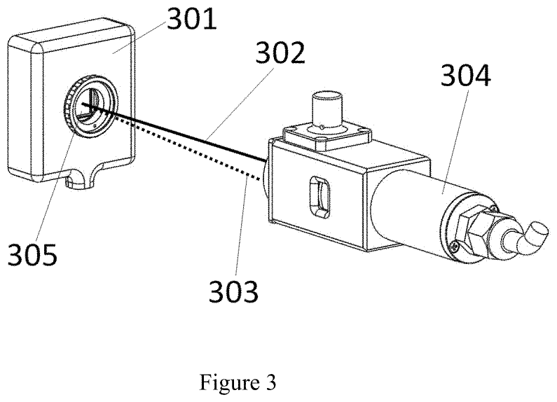

FIG. 3 is yet another embodiment wherein the laser straightness measuring apparatus is entangled with a position detector sensitive to the beam's position on its surface and partially reflects the incoming beam to be back reflected towards the input aperture of apparatus. The projected 302 emitted from the device 304 will strike the detector surface 305, generating electrical information regarding on its position on detector surface, part of the incoming beam 302 is back reflected by the detector's surface to be received by aperture of device 304. The back reflected beam 303 will be analyzed and its angular direction will be computed. 301 is the mechanical housing for said position sensitive detector.

1. An apparatus comprising:
an optical element that includes a laser beam, a beam splitter in front of an optical laser angular sensitive device with an optical principal axis, wherein the split laser propagation axis coincides with the optics' principal axis of said laser angular sensitive device;
said beam splitter in front of the optical laser angular sensitive device splits the beam such that one of the split beams coincides with said optical principal axis;
said optical laser angular sensitive device comprises of a lens and a sensitive detector which is placed in respective to the lens to generate an angular reading of a reflected incoming laser beam; and
a processor that calculates the laser angular readings deviation and activates the laser emittance.

2. The apparatus of claim 1, wherein the said laser beam is reflected by a mirror element attached to the device to be measured.

3. The apparatus of claim 1, wherein a partially-reflected mirror element back reflects a part of the laser beam and allows the other part to pass through to a position sensitive detector.

4. The apparatus of claim 1, wherein the said laser beam is configured to have different wavelengths.

5. A method comprising:
an optical element that includes a laser beam, a beam splitter in front of an optical laser angular sensitive device with an optical principal axis, wherein the split laser propagation axis coincides with the optics' principal axis of said laser angular sensitive device;
said laser beam is a reference for measurements of angular deviations from a reflective element which is attached to the device to be measured; and
the back reflected beam is monitored by an angle detection module which derives the angle by using said lens and the position sensitive device placed on its image plane.
